(19) United States
(12) Patent Application Publication
(10) Pub. No.: US 2024/0143974 A1
(43) Pub. Date: May 2, 2024

(54) AUTOMATED ANOMALY DETECTION IN MULTI-STAGE PROCESSES

(71) Applicant: MORGAN STANLEY SERVICES GROUP INC., New York, NY (US)

(72) Inventors: Sarthak Banerjee, Princeton, NJ (US); Mario Jayakumar, Kendall Park, NJ (US)

(73) Assignee: MORGAN STANLEY SERVICES GROUP INC., New York, NY (US)

(21) Appl. No.: 17/977,807

(22) Filed: Oct. 31, 2022

(51) Int. Cl. G06N 3/04

(52) U.S. Cl. CPC G06N 3/0454

(57) ABSTRACT

A system and method for constructing a probability model and automatically responding to process anomalies identified by the probability model are disclosed. Data is received for current and prior states of a process, comprising variables in at least two dimensions, and the at least two dimensions being not independently and identically distributed. A segment of a fixed number of prior states is selected and fed into a neural network to output a probability vector for each of the two or more dimensions. The Cartesian product of these probability vectors is calculated to obtain a tensor, wherein each value in the tensor represents a probability that the prior states would be followed by a given state. If the probability in the tensor associated with the present state is less than a predetermined threshold, an electronic communication is automatically generated and transmitted to a client computing device.

### FIELD OF INVENTION

This disclosure relates to systems and methods for artificial intelligence analysis of a variety of possible sequences of observed events to detect anomalies in those sequences, and more specifically, to systems and methods for preventing harm by automatically detecting a harmful present state or predicting a harmful future state based on sensor data regarding past occurrences, and automatically responding to the detection or prediction.

### BACKGROUND

Many processes, whether automated technological processes, natural processes, or human interactions, involve a procession from start to end through several discrete stages.

For example, a medical examination of an exercising individual should show a temporary increase in pulse rate, temperature, and blood pressure and a temporary decrease in blood oxygen saturation, followed by a return to baseline levels after physical activity ends. However, a change of insufficient magnitude, excessive magnitude, or with great delay may indicate a health condition that requires intervention. A weather station should observe a cyclical response of increased air pressure, higher temperatures and fairer weather, followed by decreased pressure, lower temperatures, and stormy weather. A decrease in air pressure to a certain value out of ordinary bounds may indicate an imminent tornado or major storm system. A patient experiencing chest pains should be triaged and seen by a medical professional before another patient experiencing intestinal distress. If a patient remains in the emergency room waiting more than a predetermined amount of time after disclosing a given symptom, it may indicate that a communication breakdown has occurred and that some practitioners are assuming the patient has been helped, while others are unaware that help is needed.

Markov models and other probabilistic models have been used in the past to express the probability that a currently observed state will transition into a state that an observer desires to achieve or avoid. However, existing models tend to fail to capture enough dimensions of data to be useful, and do not always capture relationships between dimensions in that data when those dimensions are not fully independent of one another.

Thus, there are advantages to having a system that captures more dimensions of input data and uses them to build a probabilistic expectation model that more quickly and accurately identifies when a particular outcome was unexpected following a prior state, and thereby identify anomalous circumstances may be in effect that require human or automated intervention.

### SUMMARY OF THE INVENTION

In order to address the limitations of existing systems for predicting state changes and identifying anomalous state changes, a novel system and method are disclosed for tracking changes in state, identifying when an anomalous change of state has likely occurred, and either informing a human operator or automatically taking action in response to the anomaly.

Because it is nearly impossible for a human operator to specify in advance all of the possible rules and heuristics that indicate an anomalous state in an ongoing process, it is preferable instead for a system to review a corpus of past state transitions that are considered to represent normal behavior. The system then “learns” rules governing state transitions that a human might never have identified, or might only have understood intuitively rather than explicitly. The probabilistic model built up during this learning process can then be used in real time to quantify how unlikely a currently observed state transition is, given the history of states in an ongoing process, and thereby identify a possible anomaly in the process.

A core idea underlying this model is in declining to assume that observed variables related to the process are independently and identically distributed (“IID”). Software dealing with probabilities of events often relies on an assumed IID behavior for variables—this allows for some instances of more efficient processing or mathematical representations, such as representing probabilities in logarithmic form and merely adding the logarithms to determine the intersection of two events occurring. However, basing a model on the assumption that variables will not be IID allows the software model to identify associations between states that a human rule-specifier might never have considered or realized.

Any continuous data format is converted into a discrete data format, so that each state can be represented as an n-dimensional tensor (for an n of at least 2) stored in computer memory as an n-dimensional array of single bits or Boolean values, with a single bit set to 1 or “true” at the only index that represents the current discrete values observed in each dimension. For example, when tracking weather conditions, the three dimensions of temperature, wind speed, and precipitation might be discretized from continuous values to {Very Low, Low, Medium, High, Very High} according to a predefined scale. A 5×5×5 tensor would be created-three dimensions of five possible values each. If, in the example, the temperature were high, the wind speed were low, and the precipitation were very low, a 0 or “false” would be stored at every index except one, and a 1 or “true” at a single index whose position represents a high temperature in the first dimension, a low wind speed in the second dimension, and a very low precipitation in the third dimension. If the weather conditions were to change upon a subsequent observation, the 1 or “true” would be placed in a different location when that state tensor is stored.

A series of sequential prior states observed in processes are segmented into chunks of varying lengths and recurrent neural networks (“RNNs”) are trained to receive a series of states as input and to output a set of probabilities, for each possible segment length, that the given state would follow the input series of prior states. If a probability of a currently observed state is determined to be sufficiently low, corrective action may be required to address an anomaly in the ongoing process.

A system for constructing a probability model and automatically responding to process anomalies identified by the probability model is disclosed. The system comprises a central server in communication with one or more sensor devices and a client computing device communicatively coupled to the central server. Non-transitory memory stores instructions that, when executed by one or more processors of the central server or of the client computing device, cause the one or more processors to perform a method disclosed herein. That method involves, among other optional steps: receiving data from one or more sensor devices comprising variables in at least two dimensions, the variables representing a current state of a process, and the at least two dimensions being not independently and identically distributed; receiving or retrieving a set of variables representing states of the process, previous to the current state; selecting a segment of a fixed number of prior states from the set of variables and feeding it to a neural network to output a probability vector for each of the two or more dimensions; calculating a Cartesian product of all probability vectors that were output to obtain a tensor of the two or more dimensions, wherein each value in the tensor represents a probability that the prior states would be followed by a state associated with that value; determining whether a probability in the tensor associated with the current state is less than a predetermined threshold; and in response to determining that the probability is less than the predetermined threshold, automatically generating an electronic communication and transmitting it to a client computing device.

Additional features include variations of the above system and method wherein
the at least two dimensions comprise a first dimension related to an operation and a second dimension related to state within the operation, or alternatively, that the at least two dimensions comprise three or more dimensions that are not hierarchically related;
the one or more sensor devices generate sensor readings on a continuous scale, and the received data comprises a conversion of those sensor readings to one of a set of predetermined discrete values;
multiple neural networks, each trained on segments of a fixed length different from a fixed length on which each other neural network was trained, are each used to generate output probability tensors, and/or a probability of anomaly is computed as a function of each of the output probability tensors' values for the current state; and/or
the client computing device, in response to receiving the electronic communication, automatically activates or deactivated a functionality of the client computing device to mitigate an expected harm to the client computing device or to a human user of the client computing device.

### BRIEF DESCRIPTION OF THE DRAWINGS

Other aspects, features and advantages will become more fully apparent from the following detailed description, the appended claims, and the accompanying drawings (provided solely for purposes of illustration without restricting the scope of any embodiment), of which:

FIG. 1 illustrates a multi-dimensional finite state diagram conceptually used within methods disclosed herein;

FIG. 2 illustrates, in simplified form, a method of representing a series of states in an ongoing process as a three-dimensional tensor;

FIG. 3 illustrates, in simplified form, a neural network model to be used in predicting a next state given a previous series of states;

FIG. 4 illustrates, in simplified form, a method of segmenting training data to obtain training values for the neural network of FIG. 3;

FIG. 5 illustrates, in simplified form, a method of training the neural network model on the various segments depicted in FIG. 4;

FIG. 6 illustrates, in simplified form, a method of segmenting presently-observed data to obtain input for the neural network of FIG. 3;

FIG. 7 illustrates, in simplified form, a method of utilizing the trained neural network model to identify that an anomaly has likely occurred and indicate its cause;

FIG. 8 illustrates, in simplified form, a system of computing devices used to receive data from input sensors or client devices and use the data to construct a model for identifying and responding to anomalies; and

FIG. 9 is a high-level block diagram of a representative computing device that may be utilized to implement various features and processes described herein.

### DETAILED DESCRIPTION

As mentioned above, a variety of use cases may be readily identified, such that an ongoing process can be divided into a number of discrete operations O₁-Oₙ, and a number of discrete states S₁-Sₙ that may be associated within each operation. For example, the operation/state paradigm might apply particularly well to driving decisions made by an autonomous vehicle, where the braking, accelerating, and park/neutral operations are mutually exclusive, and the states represent the distance to the nearest obstacle detected by a camera or other sensor. Operation/state paradigms might also apply particularly well to tracking progress by a human actor. In many instances, a human's intent at a given moment can be represented as an operation that the human will attempt to initiate and complete, proceeding through a number of states before proceeding to a next operation-unless human error, inattention, or malice causes the human to switch operations before an operation is properly complete, or to perform steps of the operation in an incorrect order or manner.

In an even more general formulation, additional dimensions beyond the first two may be incorporated, and the association between dimensions may not express the same kind of hierarchical relationship, or even any direct association between them. For example, a weather analysis system might record three or more simultaneous states, including temperature, wind speed, and precipitation. A volcano or earthquake warning system might track the intensities of seismic activity recorded at three or more monitoring stations. A medical analysis system might track three or more vital signs in a patient, including heart rate, blood pressure, blood oxygen saturation, and/or body temperature. Although many of the diagrams, mathematics, and examples in this disclosure are expressed for a two-dimensional example, it will be appreciated that the neural network training method described, which preferably receives a three-dimensional tensor representing a history of two-dimensional states, could just as easily be trained to receive a (n+1)-dimensional tensor representing a history of past states, each state being represented by an n-dimensional tensor, for some number n>2.

Regardless of the number of dimensions tracked by the model, or of what they signify, it is critical that the each of these dimensions are not independently and identically distributed (“not IID” or “non-IID”). That is, if O₁ and O₂ are two operations from the set of all operations possible in the model, p(O₁|O₂)≠p(O₁); the probability of one operation occurring, given the knowledge that a previous operation occurred, should be changed from the assumed probability of the operation occurring absent that knowledge. Similarly, if S1 and S2 are two states from the set of all possible states in the model, p(S₁|S₂)≠p(S₁), and the probability of a state occurring is influenced by the state that preceded it. In many real-world applications, this non-IID nature is intuitively obvious. For example, continuing the example of operations and states in an autonomous vehicle, it might be relatively common to shift from accelerating to out of gear or vice versa, and from reversing to out of gear or vice versa, but a sensor signal indicating a change directly from accelerating to reversing or vice versa would need to be immediately countermanded to avoid damage to a gearbox. Similarly, a sudden change in RPM of the engine in any gear from low to high may indicate a sudden source of stress on the car that would not be indicated by a transition between a low state and intermediate state, or by a transition from an intermediate state to a high state.

When operations and states are combined into ordered pairs, it is generally true that the non-IID nature is preserved, and that for each pair O₁S₁, p(O₁S₁|O₂S₂)≠p(O₁S₁). In many instances, this combination actually significantly increases the explanatory power of prior knowledge compared to considering each dimension alone. Continuing a previous example, it becomes even more concerning if the RPM of an engine goes from low to high when a vehicle is out of gear than if it does so when the vehicle is in either a forward gear or a reverse gear.

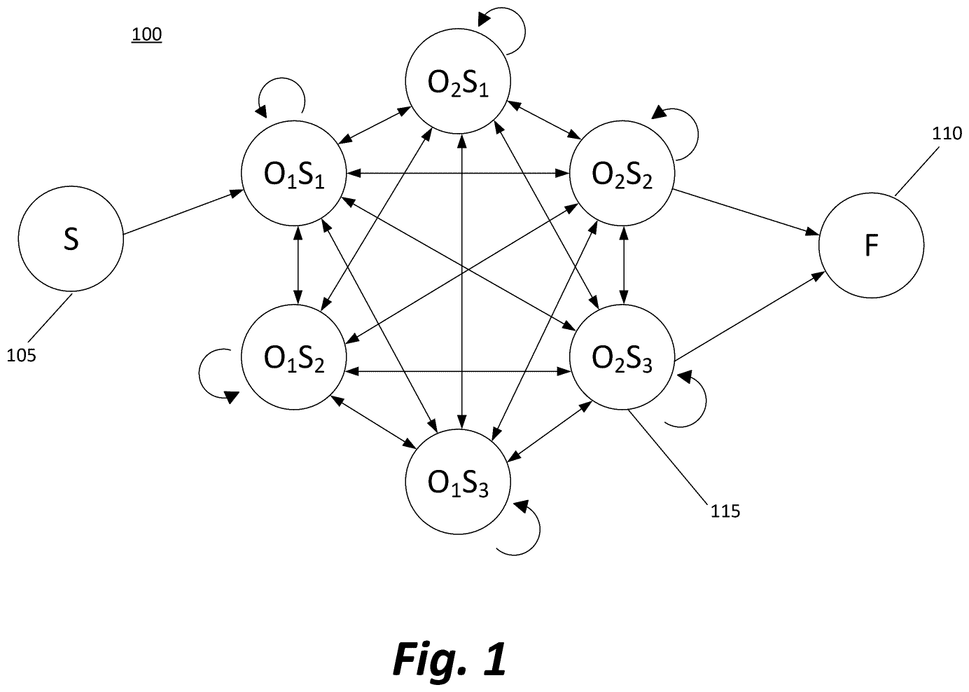

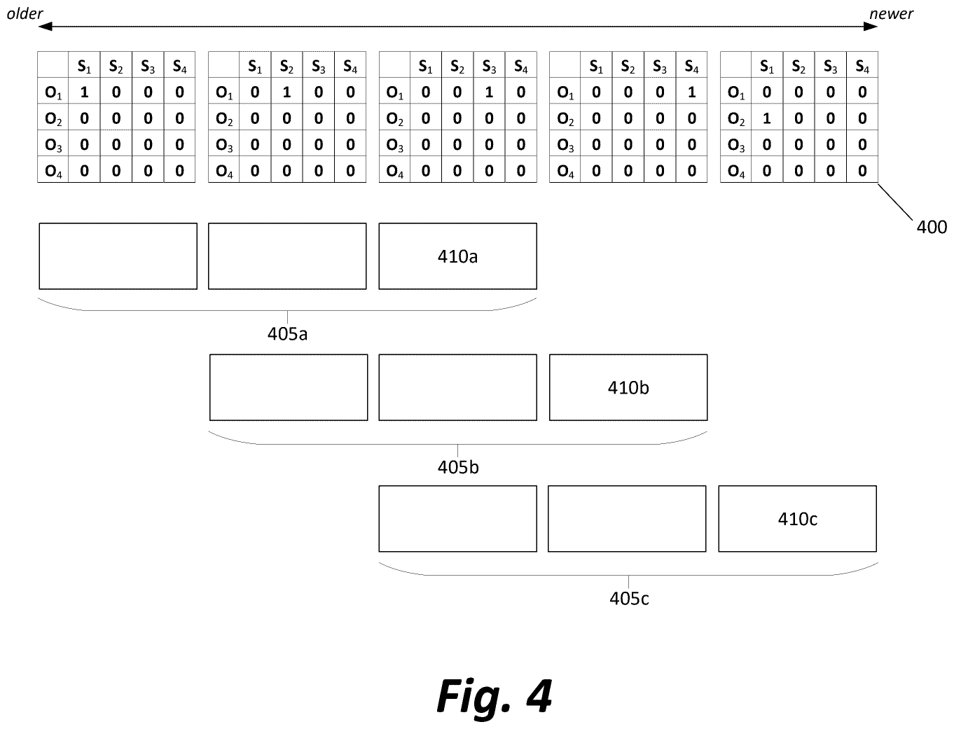

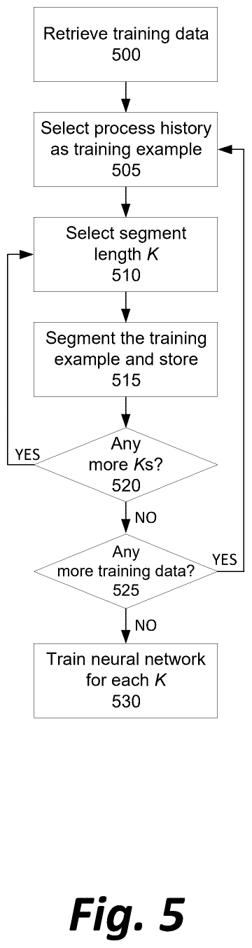

The actual computing of these probabilities of state changes and occurrences can be performed by reviewing histories of state changes in previous observations (and discussed further below in relation to FIGS. 4 and 5, which discuss the training of and then the evaluation by recurrent neural networks), and used to create a model for probabilistic state changes, as depicted in FIGS. 1, 2, and 3.

FIG. 1 illustrates a multi-dimensional finite state diagram conceptually used within methods disclosed further below.

A graph representing paths through an overall process 100 may include a start or beginning node 105, a finish or end node 110, and between them, a number of operations and a number of possible states within each of those operations, expressed as ordered pairs 115. Directed edges 120 connect every node or vertex to each other, and to themselves. Because this directed graph representation is a complete graph, including vertices with links back to themselves, the path of a process being executed may theoretically proceed without any strict sequential progression between states (for example, the state O₁S₁ may be followed by O₁S₂, then back to O₁S₁, and then O₁S₁ may be repeated a third time rather than transition at all), and also without a necessity that a state in one operation be followed by a state within the same operation (O₁S₁ may be followed by O₂S₁, which may be followed by O₁S₃). Nevertheless, because of the constraint of non-IID variables, and also because of the application of this model to real world events or situations, the progression will not be completely random, and certain transitions are much more likely than others in any given moment, in any given use case.

In a more naïve way of traditionally representing Markov models or other stochastic processes, each link between states in the process 100 might be assigned a probability that always expresses the likelihood that the source state will transition to the destination state, regardless of history. In contrast, the present disclosure seeks to express the probability of an outcome state based not only on the previous state, but also on a fuller history of previous states.

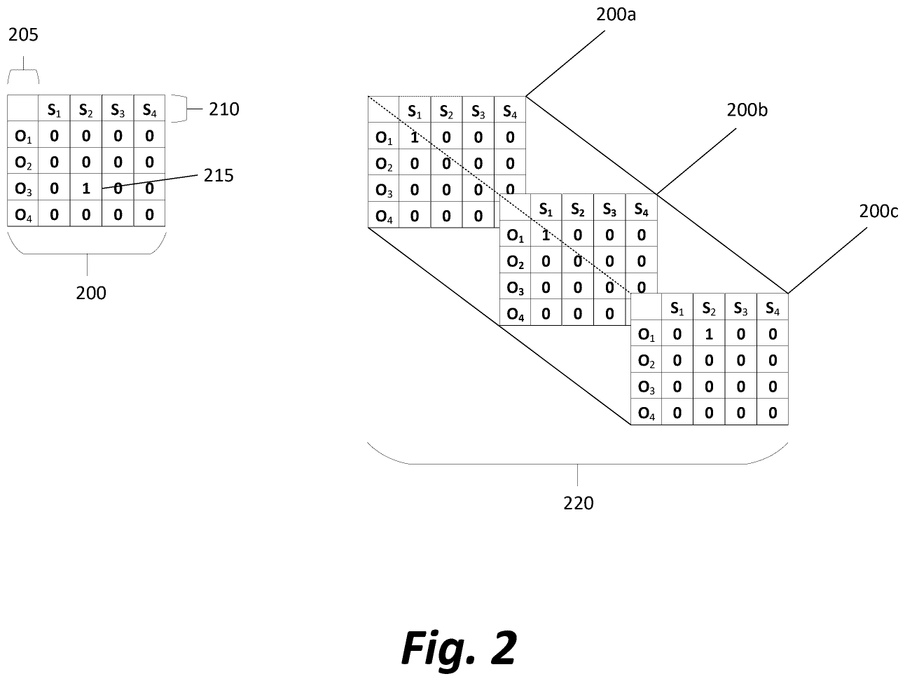

FIG. 2 illustrates, in simplified form, a method of representing a series of states in an ongoing process as a three-dimensional (or other n+l-dimensional, for n>2) tensor.

An observed or recorded state at a moment in time may be expressed as a two-dimensional tensor 200 having one dimension for every operation 205 and one dimension for every state 210. (For ease of visual depiction, only a two-dimensional operation-and-state use case is depicted here, but a three-dimensional or greater tensor could easily be envisioned, with one dimension for each dimension of the observed variables.) Each value in the tensor 200 is set to 0, except for the value 215 at the intersection of the currently observed operation and currently observed state, which is set to 1. In this instance, the tensor 200 indicates that the currently observed operation is O₃ and the state is S₂ by placing the value 1 in their respective row and column.

If multiple states have been sequentially observed or recorded, they may be represented as a series of two-dimensional tensors 200a, 200b, 200c concatenated or stacked to form a three-dimensional tensor 220 where the third dimension represents time or sequencing. For example, the tensor 220 depicted is a 4×4×3 tensor representing the sequence of states O₁S₁, O₁S₁, O₁S₂.

Again, if the underlying tensor 200 is, instead of a two-dimensional tensor, an n-dimensional tensor, the concatenation or stacking will result in an n+l-dimensional tensor 220. The at-least-three-dimensional tensor 220 will be the standardized format for input into a neural network machine learning model either to train the model or to identify an anomalous series of states in real-time.

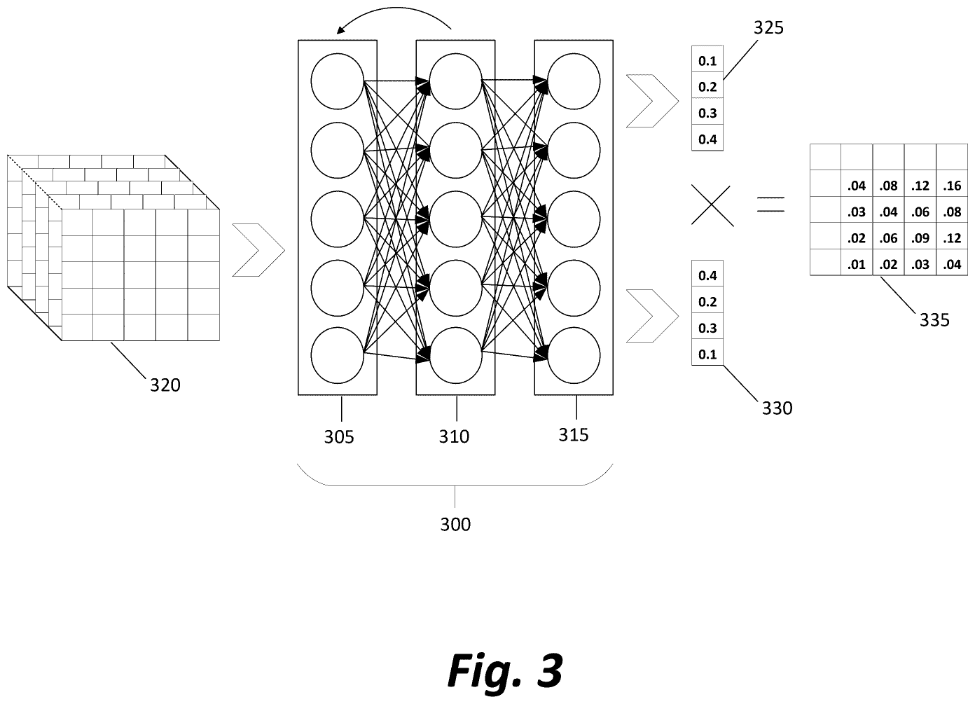

FIG. 3 illustrates, in simplified form, a neural network model to be used in predicting a next state given a previous series of states.

In a preferred embodiment, a neural network 300 is structured as a recurrent neural network (RNN), including an input layer 305, a hidden layer 310 that adds a feedback loop into the neural network, and an output layer 315. In a preferred embodiment, the PyTorch framework and Python programming language may be used to create the neural network and manage its training based on provided training data and target data. In other embodiments, it may not be necessary that the neural network be recurrent and have a feedback loop, or it is even conceivable that a machine learning technique entirely different from neural networks could be used.

When an input tensor 320 is provided to a trained instance of the RNN 300, the various layers 305, 310, 315 sequentially process it to ultimately generate two vectors 325, 330. The input tensor is preferably in the form of the at-least-three-dimensional tensor 220 described previously and depicted in FIG. 2, and the number of vectors generated may be greater than two if the input tensor has greater than three dimensions. Each vector has the same number of values as the set of operations and the set of states, respectively (or of the total number of states possible in a higher-dimensional use case). Furthermore, each vector is normalized via use of the LogSoftmax function—i.e., LogSoftmax(xᵢ)=log(exp(xᵢ)/Σᵢexp(xⱼ))—to ensure that the values in the vector sum to 1 while remaining in whatever proportion the RNN 300's output layer 315 had determined.

The ultimate output of the RNN 300 is the Cartesian product of the vectors 325, 330, which results in an output tensor 335 that resembles the state representation tensor 200, with one major caveat: instead of storing exclusively zeroes or ones in this tensor, each entry instead may be a value between 0 and 1 inclusive, representing the probability that the history represented by the input tensor 320 would normally be followed by each possible state represented by a row and column pair in the output tensor 335.

FIG. 4 illustrates, in simplified form, a method of segmenting training data to obtain training values for the recurrent neural network of FIG. 3.

Each recorded process that has proceeded from start to end can, as previously described, be modeled as an n+l-dimensional tensor 220 representing N consecutive states 400 of the process, each state being represented by an n-dimensional tensor 200. In this depicted example, N=5. In order to generate conditional probabilities that any particular state would follow any other particular state, each n+l-dimensional tensor 220 is segmented into (N−K+1) overlapping sets of states 405a, 405b, 405c, each of length K<N. In this example, K=3.

In each resulting segment of length K, the final state 410a, 410b, 410c will be used as a target during neural network training, and the prior K−1 states will be used as input to the neural network, with the error between the output and the target state being used to back-propagate changes in neural weights to reduce future error. The training method is described further below in relation to FIG. 5. Segmentation into fixed segment sizes before input to the neural network has two considerable advantages over inputting the entire set of prior states available for a process: first, it generates additional training examples by having (N−K+1) examples instead of one, and second, it allows multiple neural networks to be trained, each specializing in a particular segment length, rather than trying to train a single neural network to adapt to sets of states with differing lengths. The segmentation process can also help with identifying non-intuitive information about the process; for example, if a given state rarely or never occurs in the sets of prior K−1 states, but does occur in the final, target state, it may indicate a state tends to be a termination state for the process, either because it is an intentional goal state, or because it tends to be a state from which the process is unrecoverable and must terminate before a goal is reached. Further, if a state turns out to be highly anomalous given a longer segment but not for a shorter segment, it may indicate that there is a strong significance of a particular state at the beginning of the longer segment, and allow for greater scrutiny of upcoming states when such a state is encountered.

FIG. 5 illustrates, in simplified form, a method of training the recurrent neural network model on the various segments depicted in FIG. 4.

First, a set of prior completed processes that are believed not to have been anomalous are retrieved from data storage (Step 500). Next, for each such process history (Step 505), a segment length K is selected (Step 510). The process history is then divided into the (N−K+1) segments of length K, which are added to a repository of training examples of length K (Step 515). So long as not all desired segment lengths have been obtained (Step 520), the process is repeated for each of a series of different Ks (back to Step 510), and for each of the process histories available (Step 525, then back to Step 505). In one example embodiment, sets of repositories of training data of segment lengths four, five, six, and seven might be preferred, though longer or shorter sets of segments might be desired to avoid overfitting or underfitting the model to the available data.

Upon filling the repositories with segments of appropriate length, each repository is used to train a recurrent neural network that will specialize in the associated segment length (Step 530).

As an example of how a properly trained neural network will produce probabilities different from naively following the proportion of times a result was seen in the training data, imagine that five sets of training data are provided:
Process 1: O₁S₁, O₁S₁, O₁S₁, O₁S₂, O₁S₂
Process 2: O₁S₁, O₁S₁, O₁S₁, O₁S₃, O₁S₃
Process 3: O₁S₁, O₁S₁, O₁S₁, O₁S₂, O₁S₂
Process 4: O₁S₁, O₁S₁, O₁S₁, O₁S₂, O₁S₂
Process 5: O₁S₁, O₁S₁, O₁S₁, O₂S₁, O₂S₁

If segmentation into segments of length K=4 were to occur, we would see that the sequence (O₁S₁, O₁S₁, O₁S₁) is followed three times in the training data by O₁S₂, one time by O₁S₃, and one time by O₂S₁. Under a machine learning model that only considers state transitions, we might render this proportionally as a 0.6 probability of O₁S₂, a 0.2 probability of O₁S₃, and a 0.2 probability of O₂S₁. However, because the neural network is estimating the probability of a change in O₁ to O₁ or O₂ independently of the probability of a change from S₁ to S₁ or S₂ or S₃, and later combining them, we obtain probabilities different from the simplistic model: p(O₁S₂O₁S₁, O₁S₁, O₁S₁)=0.68, p(O₁S₃O₁S₁, O₁S₁, O₁S₁)=0.17, and p(O₂S₁|O₁S₁, O₁S₁, O₁S₁)=0.15. The difference between the O₁S₃ and O₂S₁ probabilities reflects the additional fact that throughout the training data, a transition from O₁ to O₁ is more likely than a transition from O₁ to O₂, even though the transition from O₁S₁ to O₂S₁ was equally as common as from O₁S₁ to O₁S₃.

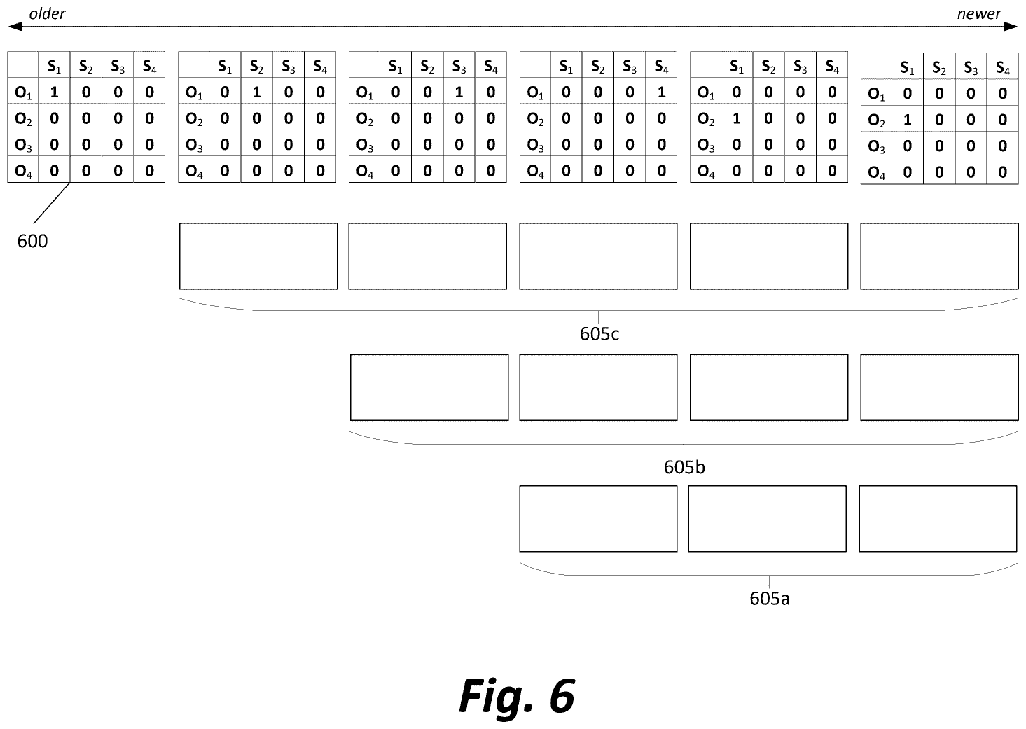

FIG. 6 illustrates, in simplified form, a method of segmenting presently-observed data to obtain input for the recurrent neural network of FIG. 3;

When various sequential states 600 of an ongoing process are being observed in real-time or after the fact, they can be divided into segments of contiguous states, similar to the segmentation process depicted in FIG. 4. In this instance, however, rather than segmentation into a single length for training a neural network on that length, multiple overlapping sets 605a, 605b, 605c of different lengths are selected, all taken at the tail of the process history before the present state. Because the length of the total history may be longer than the longest segment sought to be extracted, states at the beginning of the recorded history may not be included in any of the segments at the time of the analysis for an anomaly.

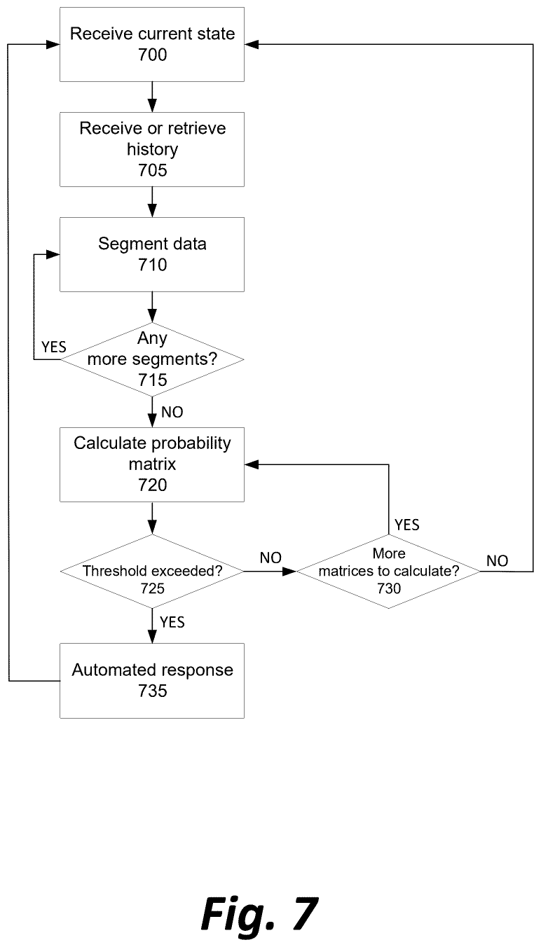

FIG. 7 illustrates, in simplified form, a method of utilizing the trained recurrent neural network model to identify that an anomaly has likely occurred and indicate its cause.

First, at least a most recent state is received (Step 700). The most recent state may be accompanied by the full history of the process, or this history may have been previously provided and is retrieved from storage (optional Step 705).

For each of a certain number of K less than the total states of the known history, the tail of the history is divided into a series of segments of one fixed length, as depicted in FIG. 6 (Step 710). Although it is possible to proceed with only a single segment, it is preferred to obtain multiple segments of varying length. Until all desired segment lengths have been obtained (Step 715), each segment is provided to the recurrent neural network associated with that segment length to obtain a probability tensor of likelihoods that the given segment would be followed by any possible state (Step 720). These probabilities are determined, as previously described, by normalizing the output of the neural network and calculating the Cartesian product of the vectors that were output for each dimension.

If consulting a probability tensor results in an anomaly probability (equal to 1—the expected probability of the current state in the tensor) above a certain predetermined threshold (Step 725), the analysis to identify an anomaly may end prematurely with the conclusion that an anomaly has occurred. If not, and if there are additional neural networks for different segment lengths that have not yet been consulted (Step 730), the process may be repeated for each of those neural networks (back to Step 720).

When a suspected anomaly is identified, an automated action is performed (Step 735). In some embodiments, a relatively lax threshold for the anomaly probability, such as 0.99 or 0.999, may be used, while in other embodiments, a hair-trigger of 0.5 or 0.75 might be used because of the potential danger or cost of not identifying an anomaly promptly.

Further, in some embodiments, rather than consulting each neural net completely independently and triggering an action if any of them are above a certain threshold, a function of all of their results may be used to decide the likelihood that an anomaly has occurred. For example, instead of the maximum anomaly probability among all neural networks being the determining factor, the minimum anomaly probability might be used instead (i.e., even if no neural network identified a 99.9% probability of anomaly, did all the neural networks identify at least a 75% probability of anomaly?), or another statistical function such as a median, average, or weighted average based on the length of segment being considered or other considerations that distinguish the neural networks.

The automated action might involve, depending on the particular embodiment or use case, triggering an audible or visible alarm from a display, speaker, or other physical light or noisemaking apparatus of an output device 210; generating an automated email, text message, instant message, or other form of communication and transmitting it to one or more output devices 210; generating a log, database record, or other data format that is stored and that may be later queried or accessed by a separate computing device; using an API of a remote software system to cause a remote server to perform a task; automatically activating a function of a device (for example, activating a sprinkler system in a building that may be on fire; activating an insulin pump in a person whose blood sugar may have risen unacceptably high); or automatically deactivating a function of a currently active device (for example, deactivating a router that is permitting harmful traffic through a network, shutting down a computer that is currently being used to commit a crime, or causing an autonomous vehicle to pull over, park, and turn off the engine).

If the automated action involved generating a message or log for eventual consultation by a human user, the message or log may contain analysis of the nature of the anomaly that can be performed based on the bifurcated vectors that were output by the neural networks and used to calculate the probability. For example, if the vector for operation indicated a relatively high value for the current state's operation, and the vector for state indicated a relatively low value for the current state value, the message or log may indicate that the operation appears correct but the state appears to be anomalous. Conversely, if the vector for state indicated a relatively high value for the current state value, and the vector for operation indicated a relatively low value for the current state's operation, the message or log may indicate that the operation appears anomalous but the state appears to be correct. If both vectors' probabilities are low, the message or log may indicate that both state and operation appear to be anomalous.

After the automated action is completed, or if the anomaly probability did not exceed the threshold, the server returns to waiting to receive a new latest state of a process or a new history of a process (back to Step 700).

Implementation as a System in Practice

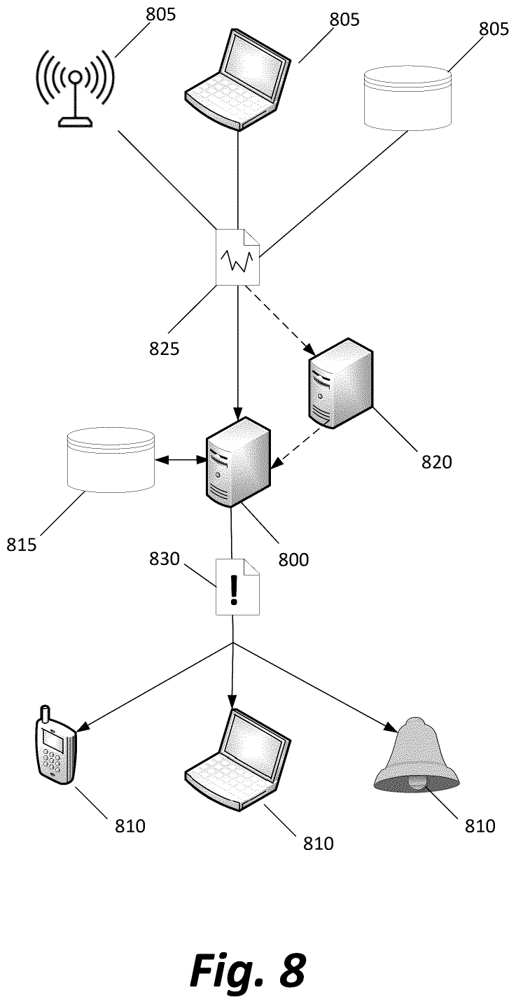

FIG. 8 illustrates, in simplified form, a system of computing devices used to receive data from input sensors or client devices and use the data to construct a model for identifying and responding to anomalies.

A central server 800 (or, in cloud-based implementations, a server instance 800) is established to remain in communication with one or more sensors or other input-generating computing devices 805 and one or more output-receiving computing devices 810. This central server stores each instance of the recurrent neural network model 300 and is capable of providing input to it to perform the anomaly detection method described in the text accompanying FIG. 7.

The input-generating computing devices 805 may be any communicatively connected devices having sensors or software that tracks a current system state, including, by way of non-limiting examples, computers, mobile phones, consoles, routers, databases, medical equipment, and environmental sensors/weather stations, and that communicates sensor readings 825 or current system states 825 to the server 800.

Similarly, the output-receiving computing devices 810 may be any communicatively connected devices having the ability to act upon the system in which an anomaly may occur, or to alert a human user of the anomaly, including, by way of non-limiting examples, computers, mobile phones, consoles, routers, databases, alarms/sirens, and digital displays, so long as they can receive communications 830 from the server 800 warning that a possible anomaly has been identified.

The server 800 may be in communication with a database 815 that stores prior observed states in general for training purposes, prior observed states of a particular ongoing process to determine whether the ongoing process has an anomaly, configuration data for the neural networks being used, or any other data needed by the server.

In some use cases, the input-generating devices 805 may generate data on a continuous scale (such as a temperature, a speed, any other numerical data, or any other form of data that does not take one of a predefined set of discrete values). In such an instance, to facilitate incorporation into the tensor structure of FIG. 2, an intermediary interpreter 820, acting as an independent server or as a pre-processing software module of the central server 800, may use predefined rules, scales, or functions to convert the continuous data into discrete values. For example, a continuous temperature provided by a digital thermometer may be converted into a value of “Low”, “Normal”, or “High” to represent hypothermia, normal bodily function, or fever, respectively. If the data is already in a discrete format, an intermediary interpreter 820 may not be necessary.

Although a particular division of functions between devices is implied with relation to the systems depicted in FIG. 8, above, other configurations are possible in which functions are divided among devices differently. For example, the functions of some or all of the central server 800, one or more input-generating computing devices 805, one or more output-receiving computing devices 810, database 815, and interpreter 820 may be performed by a single, standalone device with multiple threads executing different software modules simultaneously.

Alternatively, each system or device from among the central server 800, database 815, and interpreter 820 may in fact be a cluster of computing devices sharing functionality for concurrent processing. Further, although these various computing elements are described as if they are one computing device or cluster each, a cloud-based solution with multiple access points to similar systems that synchronize their data and are all available as backups to one another may be preferable in some embodiments to a unique set of computing devices all stored at one location. The specific number of computing devices and whether communication between them is network transmission between separate computing devices or accessing a local memory of a single computing device is not so important as the functionality that each part has in the overall scheme. What does remain of importance is that input data from some form of input device 805 is, if necessary, transformed into a discrete operation and state pair, and the pair is supplied to an RNN and used to identify an anomaly and address the anomaly, including by communicating with other devices 810 if necessary.

Particular Use Cases

The general model described above can be adapted to numerous different types of useful applications, so long as input can be received electronically representing real-world events, actions, or qualities/quantities, so long as the input can then be converted from a continuous scale to a discrete scale, if necessary, so long as the discretized input can be characterized as a meaningful operation and state pairing (or another conceptual meaning that involves two or more dimensions/variables, and wherein the dimensions/variables are not IID), and so long as electronic messaging as output from the system can be used to warn a human user of an identified anomaly or to automatically address the identified anomaly more directly.

Short Term Localized Weather Prediction: Historically, meteorological predictions have been based on a variety of input attributes with continuous numerical values, such as temperature, air pressure, wind speed, precipitation, humidity, and visibility. Instead of using the actual continuous-scale values for each of these qualities, the set of states {Very Low, Low, Medium, High, Very High} might be set, as appropriate, based on the normal values of these qualities for a given region. It is to be expected that if sensor data are obtained every hour, the temperature attribute will not change from “Very Hot” to “Cold” unless a severe anomaly is occurring, such as an approaching cold front and possible tornado activity. It is intuitively obvious that the weather conditions in one moment are not random, but are likely to be variations of the previous weather conditions, and also that the qualities of the weather are not completely independent but rather are correlated, such as low air pressure indicating a future storm. By capturing data regularly (whether hourly, more often, or less often), a comprehensive model can be established to understand how often these weather qualities change and to identify not only whether a change is anomalous, but also whether the particular change is one that necessitates an automated response. Examples of automated responses might include activating tornado sirens, mass texting mobile phones to warn of severe weather, automatically triggering functionalities of items sensitive to the weather (such as reversing the retraction of the top of a convertible automobile or putting up an automobile's windows), or activating features of a smart home such as heating, cooling, dehumidifying, etc. The model can also be trained on a particular location in a short period of time and identify what is anomalous for that location, rather than what is anomalous for all locations as a general principle of meteorology. Similar systems may also be established to warn of dangers that might not traditionally be considered “weather”, such as systems for predicting earthquakes, volcanic eruptions, tsunamis, avalanches, or other environmental dangers.

Vital Sign Anomaly Detection: A similar model can also be used for detecting anomalies in a patient's health in a medical setting. For example, each of the continuous values for heart rate, blood pressure, blood oxygen saturation, and body temperature can be observed by a monitor at a periodic interval and be converted according to a scale to the discrete values {Very Low, Low, Medium, High, Very High}. Because the vital signs of an individual do not change randomly and are likely to be correlated if there is an underlying condition, the operation-state model that assumes non-IID behavior is particularly helpful. The model can also be trained on a particular individual in a short period of time and identify what is anomalous for that individual, rather than what is anomalous for the average patient.

Autonomous vehicles: As previously mentioned, the various operations and sensor readings of an autonomous vehicle, including the car's gear, level of throttle, measured distance to the nearest obstacle, and other dimensions may be assigned discrete values or converted from continuous values to discrete values. As a result of the neural network identifying variable correlations without a rule-based system, machine learning can achieve the intuition that shifting from braking to accelerating when an obstacle is close is anomalous, and similarly that an obstacle moving from far to near without proceeding through middle distance is anomalous (and may indicate the presence of a previously unseen obstacle). In response to an identified anomaly, actions may involve initiating an evasive maneuver by a vehicle, prompting a human driver to resume control over the vehicle, notifying a third party of the anomalous behavior, pulling the vehicle over, parking it, and turning off the engine, or other actions necessary to prevent an accident or vehicular damage.

Identifying Denial of Service attacks: A number of routers in a network may routinely report numbers of incoming packets, as well as features of those packets such as source address, destination address, contents, and so on. If a malicious actor wants to shut down a website, he or she may generate a flood of packets that occupy the server for that website and prevents genuine users from accessing the website. Even if not malicious, a re-routing of network traffic due to a broken network connection or mis-configured device may flood a website and prevent its functioning. A model that receives data on a second-by-second basis from a number of routers and converts the continuous scale of traffic throughput to a discrete value such as {Low, Medium, High} may allow for anomaly detection that better distinguishes between a momentary spike in traffic that is within expected variations, and the beginning of a sustained attack or malfunction. In response to identifying the possible beginning of such an attack or malfunction, the system may transmit commands that cause certain routers to stop forwarding traffic, cause certain routers to filter traffic based on sender, destination, or other characteristics, cause certain routers to reroute traffic to a content delivery network, or cause the server to begin serving a less resource-intensive version of a website in terms of computation or bandwidth needed.

Predicting User Navigation Patterns: As a user navigates through a webpage, the current page can be characterized as a current operation, and the act of entering, reloading, interacting with, or leaving the webpage can be characterized as a current state. By building up a robust history of these operation and state changes, a neural network can be trained to identify a user interacting with the page in an anomalous way, or to predict that an undesired result will occur. For example, if a user appears to be lost, a website may be configured to automatically display a site map or search bar. If a user is likely to navigate away from the website entirely, the user may be provided with a special offer to incentivize further engagement. Predictive data can also be provided to web designers to allow for a site redesign that minimizes the likelihood that users will lose patience and cease interacting with the website.

Predicting Municipality budget needs: Many cities and municipalities of the United States periodically publish data related to their communities as part of Open City Data project, such as birth rates, death rates, residences purchased, residences rented, residences foreclosed, property taxes received, number of bus stops, number of drivers' licenses or registered cars, number of emergency hospital admissions, number of fire department responses, total residences, and so on. They also publish data related to their annual budgets such as expenditures on schools, hospitals, infrastructure, law enforcement, bureaucracy, and so on. Each of these variables can be converted from their continuous sale to a discrete value such as {Large Decrease, Small Decrease, Unchanged, Small Increase, Large Increase}. Training the neural networks using the data changes month-over-month or year-over-year can provide valuable information and identify correlations between variables both in the present and over time for a given municipality. By predicting future statistics of a city before they actually occur, a city may determine the best use of available funds to address anticipated changes, such as beginning construction of schools at the moment that birth rates increase, rather than only when the population of school-aged children is sufficiently high. The city may also be able to set policies such as taxation or zoning to anticipate or mitigate the effect of future changes in the economy and demographics of the city.

Anomalous asset trading behavior: When a broker is making a stock trade or other asset trade, the overall process goes through multiple changes over a period of time as a result of different business actions taken. Tracking these business actions from the first version of the trade to the last version provides an overview on how a trade is executed from its origination to its maturity. Examples of business operations may include “New Trading Activity”, “Upsize”, “Unwind”, “Maturity”, etc., while the state of each operation may be “Initiated”, “Modified”, “Cancelled”, and so on. If a series of actions and states of those actions go through an unexpected sequencing, it may indicate that a broker is making a human error, or that the series is being used to conceal fraudulent or illegal activity. In order to avoid financial or reputational damage and legal liability, a system operated by an organization responsible for the trade may be configured to identify an anomalous trade and prevent its final execution. This prevention may be automatic, such as by disabling a communications interface of a computing device to prevent a trading order from going out, disabling other software being used on a computing device, or revoking authorization credentials needed to access an online system. The prevention may also proceed in parallel by notifying human users (including the human making the trade or another human manager or operator of the organization) as well, through a user interface or communications medium such as email or text message.

General Computing Devices

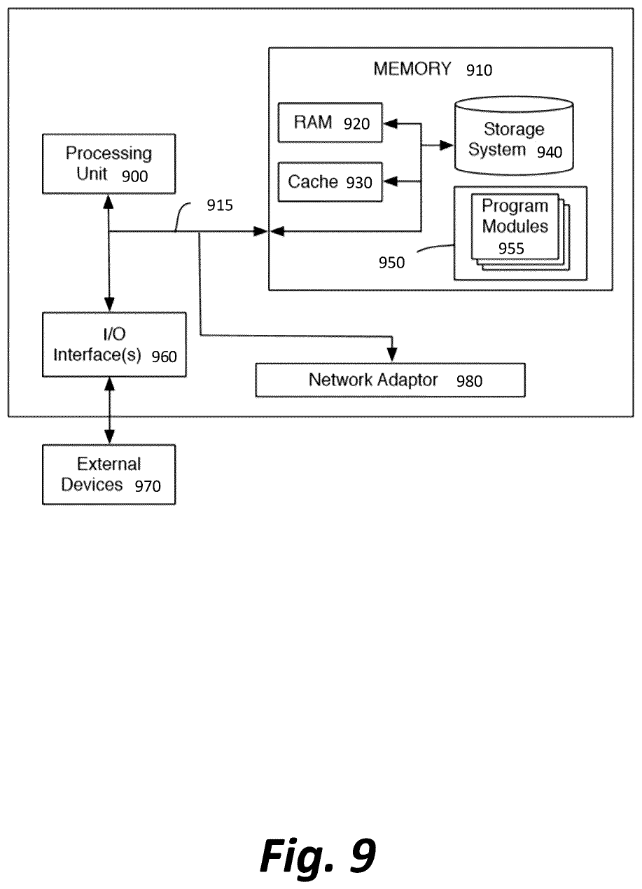

Although FIG. 8 depicts a preferred configuration of computing devices and software modules to accomplish the software-implemented methods described above, those methods do not inherently rely on the use of any particular specialized computing devices, as opposed to standard desktop computers and/or web servers. For the purpose of illustrating possible such computing devices, FIG. 9, below, describes various enabling devices and technologies related to the physical components and architectures described above.

FIG. 9 is a high-level block diagram of a representative computing device that may be utilized to implement various features and processes described herein, for example, the functionality of the central server 800, one or more input-generating computing devices 805, one or more output-receiving computing devices 810, database 815, and interpreter 820, or any other computing device described. The computing device may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 9, the computing device is illustrated in the form of a special purpose computer system. The components of the computing device may include (but are not limited to) one or more processors or processing units 900, a system memory 910, and a bus 915 that couples various system components including memory 910 to processor 900.

Bus 915 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Processing unit(s) 900 may execute computer programs stored in memory 910. Any suitable programming language can be used to implement the routines of particular embodiments including C, C++, Java, assembly language, etc. Different programming techniques can be employed such as procedural or object oriented. The routines can execute on a single computing device or multiple computing devices. Further, multiple processors 900 may be used.

The computing device typically includes a variety of computer system readable media. Such media may be any available media that is accessible by the computing device, and it includes both volatile and non-volatile media, removable and non-removable media.

System memory 910 can include computer system readable media in the form of volatile memory, such as random access memory (RAM) 920 and/or cache memory 930. The computing device may further include other removable/non-removable, volatile/non-volatile computer system storage media. By way of example only, storage system 940 can be provided for reading from and writing to a non-removable, non-volatile magnetic media (not shown and typically referred to as a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 915 by one or more data media interfaces. As will be further depicted and described below, memory 910 may include at least one program product having a set (e.g., at least one) of program modules that are configured to carry out the functions of embodiments described in this disclosure.

Program/utility 950, having a set (at least one) of program modules 955, may be stored in memory 910 by way of example, and not limitation, as well as an operating system, one or more application software, other program modules, and program data. Each of the operating system, one or more application programs, other program modules, and program data or some combination thereof, may include an implementation of a networking environment.

The computing device may also communicate with one or more external devices 970 such as a keyboard, a pointing device, a display, etc.; one or more devices that enable a user to interact with the computing device; and/or any devices (e.g., network card, modem, etc.) that enable the computing device to communicate with one or more other computing devices. Such communication can occur via Input/Output (I/O) interface(s) 960.

In addition, as described above, the computing device can communicate with one or more networks, such as a local area network (LAN), a general wide area network (WAN) and/or a public network (e.g., the Internet) via network adaptor 980. As depicted, network adaptor 980 communicates with other components of the computing device via bus 915. It should be understood that although not shown, other hardware and/or software components could be used in conjunction with the computing device. Examples include (but are not limited to) microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may use copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for constructing a probability model and automatically responding to process anomalies identified by the probability model, comprising:
a central server in communication with one or more sensor devices;
a client computing device communicatively coupled to the central server; and
non-transitory memory storing instructions that, when executed by one or more processors of the central server or of the client computing device, cause the one or more processors to:
receive data from the one or more sensor devices comprising variables in at least two dimensions, the variables representing a current state of a process, and the at least two dimensions being not independently and identically distributed;
receive or retrieve a set of variables representing states of the process, previous to the current state;
select a segment of a fixed number of prior states from the set of variables and feed the segment to a neural network to output a probability vector for each of the two or more dimensions;
calculate a Cartesian product of all probability vectors that were output to obtain a tensor of the two or more dimensions, wherein each value in the tensor represents a probability that the prior states would be followed by a state associated with that value;
determine whether a probability in the tensor associated with the current state is less than a predetermined threshold; and
in response to determining that the probability is less than the predetermined threshold, automatically generate an electronic communication and transmit it to the client computing device.

2. The system of claim 1, wherein the at least two dimensions comprise a first dimension related to an operation and a second dimension related to state within the operation.

3. The system of claim 1, wherein the at least two dimensions comprise three or more dimensions that are not hierarchically related.

4. The system of claim 1, wherein the one or more sensor devices generate sensor readings on a continuous scale, and the received data comprises a conversion of those sensor readings to one of a set of predetermined discrete values.

5. The system of claim 1, wherein multiple neural networks, each trained on segments of a fixed length different from a fixed length on which each other neural network was trained, are each used to generate output probability tensors.

6. The system of claim 1, wherein multiple neural networks are each used to generate output probability tensors, and a probability of anomaly is computed as a function of each of the output probability tensors' values for the current state.

7. The system of claim 1, wherein the client computing device, in response to receiving the electronic communication, automatically activates a functionality of the client computing device to mitigate an expected harm to the client computing device or to a human user of the client computing device.

8. The system of claim 1, wherein the client computing device, in response to receiving the electronic communication, automatically deactivates a functionality of the client computing device to mitigate an expected harm to the client computing device or to a human user of the client computing device.

9. A method for constructing a probability model and automatically responding to process anomalies identified by the probability model, comprising:
receiving data from one or more sensor devices comprising variables in at least two dimensions, the variables representing a current state of a process, and the at least two dimensions being not independently and identically distributed;
receiving or retrieving a set of variables representing states of the process, previous to the current state;
selecting a segment of a fixed number of prior states from the set of variables and feeding the segment to a neural network to output a probability vector for each of the two or more dimensions;
calculating a Cartesian product of all probability vectors that were output to obtain a tensor of the two or more dimensions, wherein each value in the tensor represents a probability that the prior states would be followed by a state associated with that value;
determining whether a probability in the tensor associated with the current state is less than a predetermined threshold; and
in response to determining that the probability is less than the predetermined threshold, automatically generating an electronic communication and transmitting it to a client computing device.

10. The method of claim 9, wherein the at least two dimensions comprise a first dimension related to an operation and a second dimension related to state within the operation.

11. The method of claim 9, wherein the at least two dimensions comprise three or more dimensions that are not hierarchically related.

12. The method of claim 9, wherein the one or more sensor devices generate sensor readings on a continuous scale, and the received data comprises a conversion of those sensor readings to one of a set of predetermined discrete values.

13. The method of claim 9, wherein multiple neural networks, each trained on segments of a fixed length different from a fixed length on which each other neural network was trained, are each used to generate output probability tensors.

14. The method of claim 9, wherein multiple neural networks are each used to generate output probability tensors, and a probability of anomaly is computed as a function of each of the output probability tensors' values for the current state.

15. The method of claim 9, wherein the client computing device, in response to receiving the electronic communication, automatically activates a functionality of the client computing device to mitigate an expected harm to the client computing device or to a human user of the client computing device.

16. The method of claim 9, wherein the client computing device, in response to receiving the electronic communication, automatically deactivates a functionality of the client computing device to mitigate an expected harm to the client computing device or to a human user of the client computing device.
